(19) United States
(12) Patent Application Publication
(10) Pub. No.: US 2025/0387912 A1
(43) Pub. Date: Dec. 25, 2025

(54) TRAINING MOBILE ROBOT TRAVERSABILITY DETECTION WITH SIMULATED DATA

(71) Applicant: Robert Bosch GmbH, Stuttgart (DE)

(72) Inventors: Marcus Gualtieri, Fremont, CA (US); Nan Tian, Foster City, CA (US); Michael Wang, Mountain View, CA (US); Liu Ren, Saratoga, CA (US)

(21) Appl. No.: 18/747,547

(22) Filed: Jun. 19, 2024

(51) Int. Cl. B25J 9/16; G06T 7/70; G06T 17/00

(52) U.S. Cl. CPC B25J 9/1666; B25J 9/1697; G06T 7/70; G06T 17/00; G06T 2207/20081

(57) ABSTRACT

A system and method are disclosed for training a machine learning model configured to determine a traversability of a real-world environment by a mobile robot based on an image of the real-world environment. The method advantageously generates high quality synthetic training data for training a traversability detection model to discriminate between traversable and untraversable regions in images captured of a real-world environment. The synthetic training data is generated through simulation of a virtual robot in a virtual environment. Once the traversability detection model is trained, it can be deployed to the mobile robot for the purpose of predicting traversability of a real-world environment.

### FIELD

The devices and methods disclosed in this document relate to mobile robots and, more particularly, to training models for traversability detection using simulated data.

### BACKGROUND

Unless otherwise indicated herein, the materials described in this section are not admitted to be the prior art by inclusion in this section.

Mobile robots take many forms and have many functions, e.g., cleaning robots, autonomous vehicles, unmanned aerial vehicles (UAVs), delivery robots, telepresence robots, etc. An essential task for a mobile robot is to identify areas of its environment that can be safely traversed. One way to recognize traversable space is for the mobile robot to travel at low speeds and detect obstacles by bumping into them. However, there are some hazards that the mobile robot should avoid contacting entirely, such as pet waste. Another way to recognize traversable space is to use LIDAR sensors to detect the positions of obstacles from a distance. However, using LIDAR in this way does not enable the mobile robot to detect all types of hazards and does not enable the mobile robot to distinguish between different types of hazards, such as a wall versus a puddle.

To overcome some of these challenges, some prior works have proposed that a mobile robot could incorporate a vision-based machine learning model that receives images of the environment and predicts the traversability of regions of the environment captured in the image. However, training modern machine learning models requires a lot of correctly labeled training data. Labeling real images can be tedious and error prone. Since manually labeling images is expensive, such prior works have suggested automatically labelling images based on experience. Particularly, once a bumper sensor on the mobile robot detects a bump event, images just prior to the bump event are labeled as non-traversable. However, this introduces the problem of associating images with a future bump event, which may be a noisy process due to a miscalculation of the robot's odometry or external events, such as pets, modifying the robot's trajectory.

Accordingly, what is needed is a method for training a machine learning model to predict the traversability of regions of an environment captured in an image, which does not require large amounts of manually labeled training data.

### SUMMARY

A method is disclosed for training a machine learning model configured to determine a traversability of a real-world environment by a mobile robot based on an image of the real-world environment. The method comprises generating a virtual environment using a plurality of three-dimensional models. The method further comprises generating a synthetic image of the virtual environment. The method further comprises determining a label mask for the synthetic image based on a simulation of a virtual robot in the virtual environment, the label mask indicating a traversability of respective regions of the virtual environment captured in the synthetic image. The method further comprises training the machine learning model based on the synthetic image and the label mask.

### BRIEF DESCRIPTION OF THE DRAWINGS

The foregoing aspects and other features of the system and methods are explained in the following description, taken in connection with the accompanying drawings.

FIG. 1 summarizes components and operations of a mobile robot system.

FIG. 2A shows an exemplary embodiment of the mobile robot.

FIG. 2B shows an exemplary embodiment of the computer system.

FIG. 3 shows a flow diagram for a method for training a machine learning model configured to determine a traversability of a real-world environment by a mobile robot based on an image of the real-world environment.

FIG. 4 shows different types of untraversable robot configurations.

FIG. 5 shows several exemplary configurations of a virtual robot.

FIG. 6 shows a flow diagram for a method for determining a traversability label for a particular pixel in a synthetic image.

FIG. 7 summarizes a ray tracing process using a pinhole camera model.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

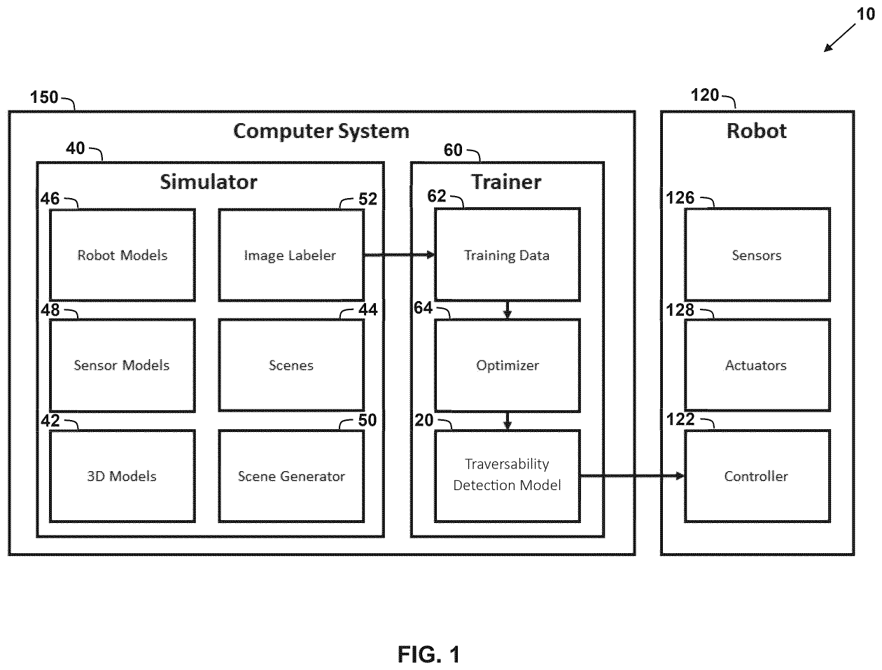

With reference to FIG. 1, components and operations of a mobile robot system 10 are summarized. The mobile robot system 10 includes at least one mobile robot 120 configured to perform a task in an environment. The mobile robot system 10 is advantageously configured to leverage a traversability detection model 20 configured to determine a traversability of a real-world environment based on images of the real-world environment. The traversability detection model 20 is of any type of model in the art of machine learning, including neural networks, support vector machines, Gaussian mixture models, etc.

In general, the mobile robot 120 includes a controller 122 that is configured to operate one or more sensors 126 and one or more actuators 128 to autonomously navigate an environment to perform a task. In some embodiments, the mobile robot 120 may comprise a cleaning robot, such as a robot vacuum or a robot mop, that is configured to navigate the environment to clean a floor surface in the environment. In other embodiments, the mobile robot 120 may comprise an autonomous road vehicle, an unmanned aerial vehicle (UAV), a delivery robot, or a telepresence robot. However, it should be appreciated by those of ordinary skill that the systems and methods described herein may be applicable to a wide variety of mobile robots that autonomously navigate an environment to perform a task.

As the mobile robot 120 is operated to perform tasks in the environment, the controller 122 operates the sensors 126 to capture images of the environment, as well as other sensor data, to detect positions of walls, objects, or other obstructions in the environment for the purpose of mapping, navigation, motion planning, and trajectory optimization tasks. The mobile robot 120 advantageously leverages the traversability detection model 20 to process the captured images and determine which portions of the environment captured in the image are traversable or not traversable. Traversability detection normally occurs in the mobile robot by the controller 122, but it could also occur in a remote server, where the input images and output results are transmitted via a network connection. Based on the traversability information, as well as based on mapping data or other sensor information, the controller 122 operates the actuators 128 to navigate the environment and to perform tasks in the environment.

With continued reference to FIG. 1, the mobile robot system 10 further includes a computer system 150, which could be physically located in the robot (e.g., the controller 122), near the robot (e.g., a local PC in the same building), or remote (e.g., in the cloud). The computer system 150 advantageously includes program instructions corresponding to a simulator 40 which are executed to generate synthetic training data for training the traversability detection model 20. Additionally, the computer system 150 includes program instructions corresponding to a trainer 60 which are executed to train the traversability detection model 20 to discriminate between traversable and untraversable regions in images captured of a real-world environment.

For the purpose of generating synthetic images, the simulator 40 of the computer system 140 leverages a plurality of models. The models leveraged by the simulator 40 include 3D models 42 (e.g., triangle meshes) of virtual objects that can be combined to generate virtual scenes 44. The models leveraged by simulator 40 also include a robot model 46 that simulates not only the spatial size and shape of the mobile robot 120, but also the mechanics by which the mobile robot 120 moves through an environment and perform tasks. Finally, the models leveraged by the simulator 40 include sensor models 48, at least including a camera model (e.g., a pinhole camera), that simulates how the sensors 126 of the mobile robot measure sensor data.

The computer system 150 executes a scene generator 50 of the simulator 40 to randomly or procedurally generate unique virtual environments, referred to herein as virtual scenes 44. For example, a household scene could be generated by randomly selecting a room layout and randomly positioning furniture, lights, and other household objects into the various rooms. The generated virtual scenes 44 are stored in memory. The computer system 150 places a virtual robot, based on the robot model 46, into the virtual scene 44 at variety of different traversable locations and generates synthetic images captured from the perspective of the virtual robot, using the camera model.

Finally, the computer system 150 executes an image labeler 50 of the simulator 40 to determine ground truth traversability labels for the synthetic images, e.g., in the form of a label mask. Particularly, the computer system 150 automatically computes which regions in a synthetic image correspond to traversable areas or to untraversable areas. As used herein “untraversable” areas in an environment broadly includes obstacles (e.g., low furniture) that substantially prevent traversal by the mobile robot, as well as hazards (e.g., liquids, pet waste) and unstable terrain (e.g., stairs, sand) that do not necessarily prevent traversal by the mobile robot, but which should nonetheless not be traversed. The image labeler 50 includes collision checking, for locating obstacles, and forward dynamics (e.g., a discrete-time solver of Newton's equations of motion), for stability checking. Since the computer system 150 has full knowledge of the simulated environment, the synthetic images are labeled “perfectly”, assuming the simulation is realistic. Building on these innovations, generating training data for traversability detection becomes practical.

Once a sufficient corpus of training data 62 is generated (i.e., synthetic images with ground truth traversability labels), the computer system 150 executes the trainer 60 to train the traversability detection model 20 to predict traversable and untraversable regions of an environment based on images of the environment. In particular, the computer system 150 trains the traversability detection model 20 based on the generated training data 62 using an optimizer 64. The optimizer 64 is implemented with any algorithm in the art of machine learning for fitting a model to data, including gradient descent, stochastic gradient descent, Newton's method, etc. In some embodiments, the synthetic training data 62 may be augmented with real training data including real images that have been manually labeled or labeled using further sensing systems, such as LIDAR or bumper sensors.

The traversability detection model 20 is then used by the mobile robot to detect traversable regions for safe navigation. Particularly, as the mobile robot 120 is operated to perform tasks in the environment, the controller 122 executes the trained traversability detection model 20 to generate traversability labels based on images of the real-world environment. The controller 122 generates operating commands to operate the actuators 128 at least in part based on the traversability labels.

In some embodiments, the computer system 150 also executes a further trainer (not shown) the trainer 60 to train the controller 122 to generate actuator commands using the simulator 40 and reinforcement learning algorithms. Particularly, the input state to the controller 122 includes an image labeled with traversability, and the output action includes commands for moving the robot. The computer system 150 trains the controller 122 to generate the commands using a simulated robot that moves a simulated environment and the controller 122 learns to maximize the expected future reward.

### Mobile Robot

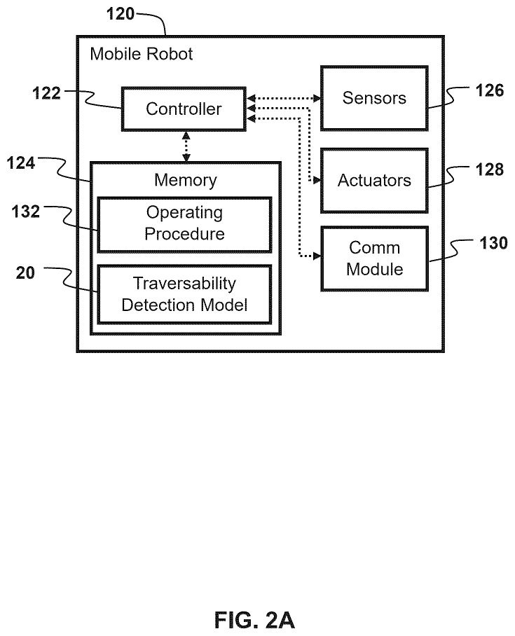

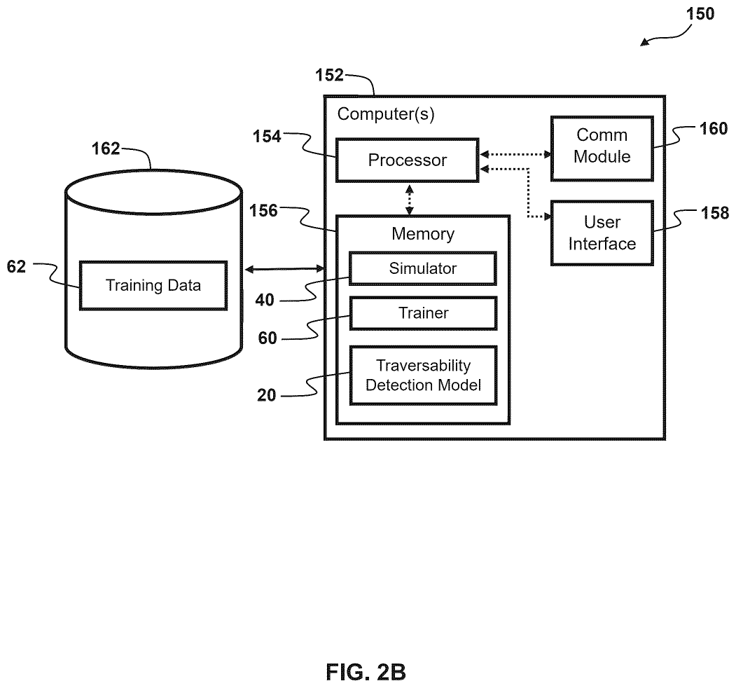

FIG. 2A shows an exemplary embodiment of the mobile robot 120. In the illustrated embodiment, the mobile robot 120 comprises, for example, the controller 122, the memory 124, the one or more sensors 126, the one or more actuators 128, and at least one network communications module 130. It will be appreciated that the illustrated embodiment of the mobile robot 120 is only one exemplary embodiment and is merely representative of any of various manners or configurations of mobile robots that autonomously navigate an environment to perform a task.

The controller 122 is configured to execute instructions to operate the mobile robot 120 to enable the features, functionality, characteristics and/or the like as described herein. To this end, the controller 122 is operably connected to the memory 124, the one or more sensors 126, and the one or more actuators 128. The controller 122 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the controller 122 may include a system with a central processing unit, graphics processing units, multiple processing units, dedicated circuitry for achieving functionality, programmable logic, or other processing systems.

The memory 124 is configured to store data and program instructions that, when executed by the controller 122, enable the mobile robot 120 to perform various operations described herein. The memory 124 may be any type of device capable of storing information accessible by the controller 122, such as a memory card, ROM, RAM, hard drives, discs, flash memory, or any of various other computer-readable media serving as data storage devices, as will be recognized by those of ordinary skill in the art. The controller 122 is configured to execute program instructions of an operating procedure 132, which is stored in the memory 124, to navigate the environment to perform a task, such as cleaning a floor surface in the environment. The operating procedure 132 utilizes the traversability detection model 20 to aid in navigating the environment to perform the task, as mentioned above.

The one or more sensors 126 may comprise a variety of different sensors, such as cameras, structured light sensors, LIDAR sensors, RADAR sensors, SONAR sensors, and the like. The sensors 126 at least include one or more cameras configured to capture a plurality of images of the environment as the mobile robot 120 navigates through the environment. The camera(s) generate image frames of the environment, each of which comprises a two-dimensional array of pixels. Each pixel has corresponding photometric information (color, intensity, and/or brightness). In some embodiments, the camera(s) are configured to generate RGB-D images in which each pixel has corresponding photometric information and geometric information (depth and/or distance). In such embodiments, the camera(s) may take the form of an RGB camera that operates in association with a LIDAR or IR sensor, in particular a LIDAR camera or IR camera, configured to provide both photometric information and geometric information. The LIDAR camera or IR camera may be separate from or directly integrated with the RGB camera. Alternatively, or in addition, the camera may comprise two RGB cameras configured to capture stereoscopic images, from which depth and/or distance information can be derived. Based on RGB-D images captured as the mobile robot 120 navigates the environment, the mobile robot 120 may implement visual and/or visual-inertial odometry methods such as simultaneous localization and mapping (SLAM) techniques.

In some embodiments, the sensors 126 include a light sensor (e.g., LIDAR or any other time of flight or structured light-based sensor), configured to emit measurement light (e.g., lasers) and receive the measurement light after it has reflected throughout the environment. In time-of-flight based embodiments, the controller 122 is configured to calculate times of flight and/or return times for the measurement light. In structured light-based embodiments, the controller 122 applies an algorithm to extract a 3D profile of surfaces onto which the structured light is projected (e.g., based on a fringe pattern generated on a surface).

In some embodiments, the sensors 126 include sensors configured to measure one or more accelerations, rotational rates, and/or orientations of the mobile robot 120. In one embodiment, the sensors 126 include one or more accelerometers configured to measure linear accelerations of the mobile robot 120 along one or more axes (e.g., roll, pitch, and yaw axes), or one or more gyroscopes configured to measure rotational rates of the mobile robot 120 along one or more axes (e.g., roll, pitch, and yaw axes), and/or an inertial measurement unit configured to measure all of the above.

The one or more actuators 128 at least include motors of a locomotion system that, for example, drive a set of wheels to cause the mobile robot 120 to move throughout the environment to perform the task. The actuators 128 may similarly incorporate brakes or propellors to aid in locomotion. Additionally, the actuators 128 include a variety of motors, joints, and the like that are operated to perform tasks in the environment. In some embodiments, the actuators 128 include a vacuum suction system configured to vacuum a floor surface as the mobile robot 120 navigates through the environment. Mobile robots 120 that perform other tasks in the environment may, of course, include different types of actuators 128 that are suitable to other tasks.

The network communications module 130 may comprise one or more transceivers, modems, processors, memories, oscillators, antennas, or other hardware conventionally included in a communications module to enable communications with various other devices, at least including the computer system 150. Particularly, the network communications module 130 generally includes a Wi-Fi module configured to enable communication with a Wi-Fi network and/or Wi-Fi router (not shown). Additionally, the network communications module 130 may include a Bluetooth® module (not shown). Finally, the network communications module 130 may include one or more cellular modems configured to communicate with wireless telephony networks.

The mobile robot 120 may also include a respective battery or other power source (not shown) configured to power the various components within the mobile robot 120. In one embodiment, the battery of the mobile robot 120 is a rechargeable battery configured to be charged when the mobile robot 120 is connected to a base station that is configured for use with the mobile robot 120.

### Computer System

FIG. 2B shows an exemplary embodiment of the computer system 150. The computer system 150 comprises one or more computers 152 and one or more storage devices 162 (e.g., databases). Each computer 152 includes, for example, a processor 154, a memory 156, a user interface 158, and a network communications module 160. It will be appreciated that the illustrated embodiment of the computers 152 is only one exemplary embodiment of a computer 152 and is merely representative of any of various manners or configurations of a personal computer, server, or any other data processing system that is operative in the manner set forth herein.

The processor 154 is configured to execute instructions to operate the computer 152 to enable the features, functionality, characteristics and/or the like as described herein. To this end, the processor 154 is operably connected to the memory 156, the user interface 158, and the network communications module 160. The processor 154 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 154 may include a system with a central processing unit, graphics processing units, multiple processing units, dedicated circuitry for achieving functionality, programmable logic, or other processing systems.

The storage device 162 is configured to store the training data 62 that is used to train the traversability detection model 20. The storage device 162 may be any type of long-term non-volatile storage device capable of storing information accessible by the processor 154, such as hard drives, solid-state drives, or any of various other computer-readable storage media recognized by those of ordinary skill in the art. Likewise, the memory 156 is configured to store program instructions that, when executed by the processor 154, enable the computer 152 to perform various operations described herein, including the simulator 40 for generating synthetic training data and the trainer 60 for training the traversability detection model 20. The memory 156 may be any type of device or combination of devices capable of storing information accessible by the processor 154, such as memory cards, ROM, RAM, hard drives, discs, flash memory, or any of various other computer-readable media recognized by those of ordinary skill in the art.

The computer 152 may be operated locally or remotely by an administrator. To facilitate local operation, the computer 152 may include the user interface 158. In at least one embodiment, the user interface 158 may suitably include an LCD display screen or the like, a mouse or other pointing device, a keyboard or other keypad, speakers, and a microphone, as will be recognized by those of ordinary skill in the art. Alternatively, in some embodiments, an administrator may operate the computer 152 remotely from another computing device which is in communication therewith via the network communications module 160 and has an analogous user interface.

The network communications module 160 provides an interface that allows for communication with any of various devices, at least including the mobile robot 120. In particular, the network communications module 160 may include a local area network port that allows for communication with any of various local computers housed in the same or nearby facility. Generally, the computer 152 communicates with remote computers over the Internet via a separate modem and/or router of the local area network. Alternatively, the network communications module 160 may further include a wide area network port that allows for communications over the Internet. In one embodiment, the network communications module 160 is equipped with a Wi-Fi transceiver or other wireless communications device. Accordingly, it will be appreciated that communications with the computer 152 may occur via wired communications or via the wireless communications. Communications may be accomplished using any of various known communications protocols.

### Methods for Training and Providing a Traversability Detection Model for a Mobile Robot

A variety of methods and processes are described below for training and providing a traversability detection model for use by a mobile robot. In these descriptions, statements that a method, processor, and/or system is performing a task or function refers to a controller or processor (e.g., the processor 154 of the computer 152 or the controller 122 of the mobile robot 120) executing programmed instructions stored in non-transitory computer readable storage media (e.g., the memory 156 of the computer 152 or the memory 124 of the mobile robot 120) operatively connected to the controller or processor to manipulate data or to operate one or more components in the computer 152 or the mobile robot 120 to perform the task or function. Additionally, the steps of the methods may be performed in any feasible chronological order, regardless of the order shown in the figures or the order in which the steps are described.

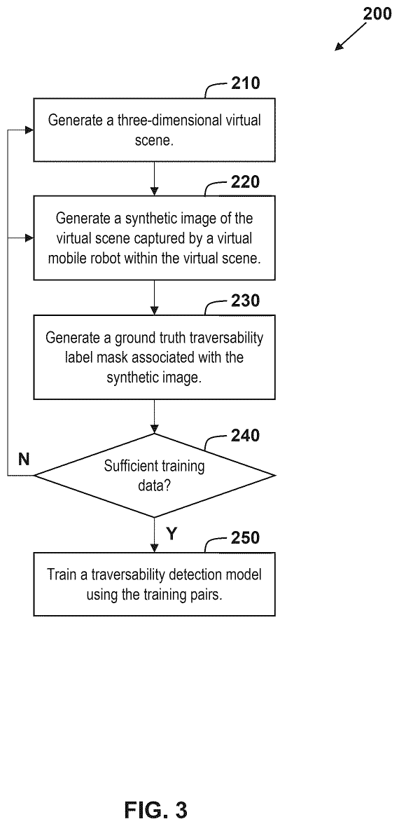

FIG. 3 shows a flow diagram for a method 200 for training a machine learning model configured to determine a traversability of a real-world environment by a mobile robot based on an image of the real-world environment. The method 200 advantageously generates high quality synthetic training data for training a machine learning model to discriminate between traversable and untraversable regions in images captured of a real-world environment. The synthetic training data is generated through simulation of a virtual robot in a virtual environment.

The method 200 begins with generating a three-dimensional virtual scene (block 210). Particularly, the processor 152 of the computer system 150 generates at least one unique virtual environment using a plurality of three-dimensional models of virtual objects and other environmental geometry, such as floors and walls. In one embodiment, the processor 152 randomly or procedurally generates the geometry of the virtual environment with primitive shapes or with a dataset of 3D models and/or 3D polygon meshes (i.e., the 3D models 42), such as the Zillow Indoor Dataset or ShapeNet. In one embodiment, the processor 152 randomly or procedurally generates an environment layout to generate a virtual environment. In one embodiment, the processor 152 randomly or procedurally selects virtual objects from a plurality of virtual object models and randomly or procedurally determines positions of the virtual objects within the virtual environment. In one example, the processor 152 generates a household scene by randomly selecting a room layout from a plurality of predefined room layouts and randomly or procedurally positioning furniture, lights, and other household objects into the various rooms. In another example, the processor 152 generates a city scene by randomly or procedurally generating a road layout and randomly or procedurally placing buildings, pedestrians, and vehicles into the virtual scene. The processor 152 stores the one or more unique virtual environments in the memory 156 or in the storage devices 162.

In at least some embodiments, the virtual objects within the generated virtual environments are labeled with relevant semantic information. Particularly, some virtual objects may represent hazards in the environment, such as pet waste or a puddle of water. In such cases, these virtual objects will be labeled as hazards. As discussed in greater detail below, at least in some embodiments, hazards may be treated differently compared to other obstacles in the virtual environment.

The method 200 continues with generating a synthetic image of the virtual environment (block 220). Particularly, the processor 152 generates a synthetic image of the virtual environment. To this end, the processor 152 first defines a configuration of a virtual robot within the virtual environment. However, it will be appreciated that only certain configurations for the virtual robot are valid within the virtual environment. Particularly, the processor 152 must confirm that the defined configuration is traversable by the virtual robot, e.g., using the robot model 46. Once a traversable configuration for the virtual robot is defined, the processor 152 renders a synthetic image of the virtual environment from a perspective of the virtual robot with the configuration, using a virtual camera of the virtual robot and a corresponding camera model (i.e., one of the sensor models 48).

It should be appreciated that, as used herein the “configuration” of a real-world robot or of a virtual robot refers to a specification of the location of every part of the robot or every point on the robot in physical or virtual 3D space. As an example, if the robot is a substantially rigid body, the configuration of the robot comprises a 3D position and orientation of the robot within the environment. However, if the robot is a non-rigid body, the configuration of the robot may include multiple positions, angles, or orientations of multiple parts of the robot in order to completely specify its spatial state. For example, if the robot includes a wheeled base with a robotic arm arranged on top of the wheeled base having rigid links and actuatable joints, then the configuration of the robot might be specified as a 3D position and orientation of the wheeled base and by the angle of each actuatable joint of the robotic arm or the position and orientation of each rigid link of the robotic arm.

In at least some embodiments, in order to identify a valid traversable configuration of the virtual robot within the virtual environment, the processor 152 randomly and iteratively selects candidate configurations of the virtual robot within the virtual environment. For each candidate configuration, the processor 152 checks whether the candidate configuration of the virtual robot is traversable within the virtual environment, until a valid traversable configuration is identified. The processor 152 selects a particular candidate configuration in response determining that the candidate configuration being traversable.

In some embodiments, prior to the labeling process, the processor 152 determines candidate configurations of the virtual robot across the entirety of the configuration space. In other words, the processor 152 determines candidate configurations of the virtual robot for all possible locations in the virtual environment. In this case, the processor 152 computes the total configuration space once for each unique virtual environment, and selects candidate configurations from the configuration space.

The processor 152 selects candidate configurations of the virtual robot in the virtual environment either randomly or uniformly according to some procedure. In one embodiment, the processor 152 determines the candidate configurations uniformly at random in a bounded configuration space. In another embodiment, the processor 152 determines the candidate configurations randomly but with preference to regions where the current set of samples is sparse, e.g., like Rapidly Exploring Random Trees (RRT). In another embodiment, the processor 152 determines the candidate configurations procedurally on a d-dimensional grid, where d is the dimension of the configuration space, and grid spacing is given ahead of time. In another embodiment, the processor 152 determines the candidate configurations procedurally by moving the robot along boundaries of the virtual environment.

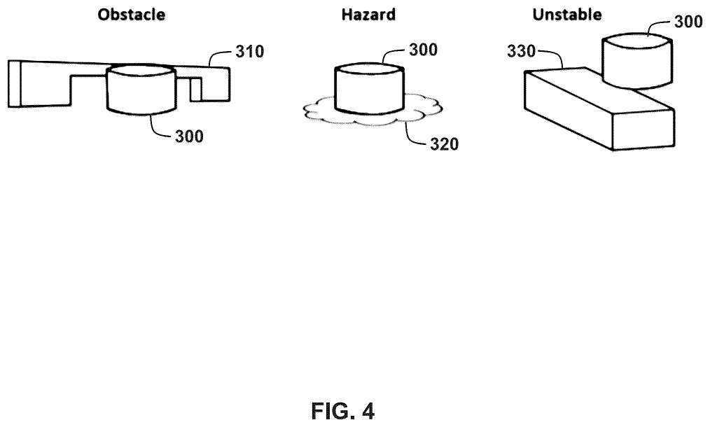

In order to identify a valid traversable configuration of the virtual robot within the virtual environment, the processor 152 evaluates whether the candidate configuration places the virtual robot in collision, in contact with a hazardous substance, or in an unstable state. FIG. 4 shows different types of untraversable robot configurations. In the illustration, the virtual robot 300 is represented as a black cylinder. On the left, the virtual robot 300 is illustrated as being in collision with an obstacle 310. In the center, the virtual robot 300 is illustrated as being in contact with a hazard 320. On the right, the virtual robot 300 is illustrated as being unstable on a surface 330.

To check whether a candidate configuration of the virtual robot is in collision with an obstacle, the processor 152 determines whether the virtual robot with the candidate configuration intersects with an obstacle of the virtual environment. In at least one embodiment, the processor 152 uses a 3D mesh-based collision checker, such as Open Dynamics Engine or NVIDIA Omniverse, to check if the robot is in collision with obstacles. An obstacle may include any virtual object of the virtual environment. It should be appreciated that “virtual object” as used herein may refer to any portion of the virtual environment, including virtual ground/terrain, virtual walls, virtual floors, and virtual ceilings, as well as virtual objects placed into the virtual environment that represent furniture, trees, toys, etc. In response to the virtual robot being in collision with (i.e., intersecting) an obstacle, the processor 152 determines that the candidate configuration is not traversable.

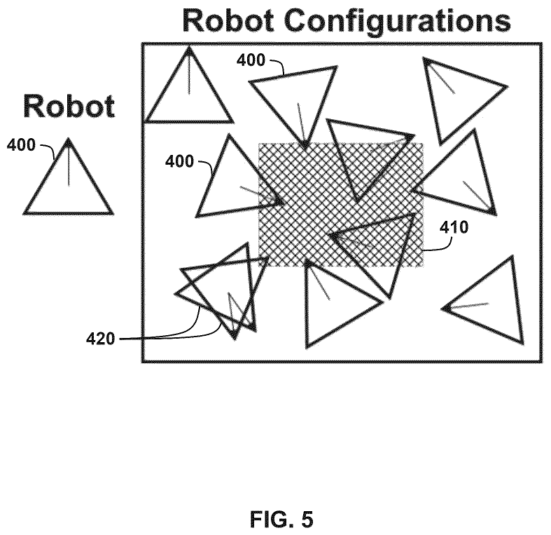

FIG. 5 shows several exemplary configurations of a virtual robot 400. In the illustration, configurations of the virtual robot 400 are shown as triangles and the heading of the virtual robot 400 is indicated by an arrow (for legibility, only a subset are labeled with the reference number 400). An obstacle 410 is indicated by the cross-hatched region. Since the illustrated virtual robot 400 is flat and triangular, the robot's configuration consists of its position and orientation. Here, configurations are sampled randomly in the virtual environment. Partially cross-hatched virtual robots 400 are in collision with the obstacle 410 at the center of the virtual environment. As can be seen, the position and orientation are both important, e.g., the two candidate configurations 420 in the bottom-left have the same position, but one orientation is in collision and the other is not. Similarly, if the robot 400 has arms or propellers, the positions of the arms/propellers would also influence traversability.

To check whether a candidate configuration of the virtual robot is in contact with a hazard, the processor 152 first determines whether the virtual robot with the candidate configuration intersects with a virtual hazard (i.e., a virtual object labeled as a hazard) of the virtual environment, as similarly discussed above. In at least one embodiment, the processor 152 uses a 3D mesh-based collision checker, such as Open

Dynamics Engine or NVIDIA Omniverse, to check if the robot is in contact with a hazardous substance. However, some hazards may be represented in the virtual environment as a flat, two-dimensional element. For example, a puddle of water may be represented by a region of a virtual surface that is labeled as a puddle of water or represented by a two-dimensional virtual object on the virtual surface. In such cases, the processor 152 also determines whether the virtual robot with the candidate configuration is above a two-dimensional element corresponding to a virtual hazard (i.e., a virtual object labeled as a hazard). For example, in one embodiment, the processor 152 projects the model of the virtual robot onto the virtual floor or virtual terrain and determines whether the two-dimensional element corresponding to a hazard intersects with the projection of the virtual robot. In response to the virtual robot being in collision with (i.e., intersecting) a hazard or otherwise being in contact with a hazard (e.g., being directly above) the processor 152 determines that the candidate configuration is not traversable.

Finally, to check whether a candidate configuration of the virtual robot is stable, the processor 152 determines whether a center of mass of the virtual robot with the candidate configuration is located over a virtual floor or is located over open space. In some embodiments, in response to the center of mass being located over open space, the processor 152 determines that the candidate configuration is not traversable. In some embodiments, the processor 152 similarly checks whether multiple relevant portions of the robot (e.g., locations corresponding to wheels of the virtual robot) are located over a virtual floor or are located over open space. Additionally, or alternatively, to check whether a candidate configuration of the virtual robot is stable, the processor 152 simulates motion of the virtual robot through the virtual environment in the presence of gravity a predetermined number of time steps forward. If based on the simulation, the virtual robot falls or tilts beyond a predetermined limit during this simulation, the processor 152 determines that the candidate configuration is not traversable.

In some embodiments, the processor 152 additionally determines candidate velocities and/or accelerations of the virtual robot, in a similar manner as generating the candidate configurations. It should be appreciated that the velocity and/or acceleration of the virtual robot are derivatives of the configuration of the virtual robot. In some embodiments, the processor 152 determines whether the virtual robot will become stuck in a small gap in a virtual floor based on the candidate velocities and/or accelerations.

With continued reference to FIG. 3, after a traversable configuration of the virtual robot is identified, the processor 152 renders a synthetic image of the virtual environment from a perspective of the virtual robot with the traversable configuration, using a virtual camera of the virtual robot and a corresponding camera model (i.e., one of the sensor models 48). In some embodiments, the processor 152 renders the synthetic image using one or more known graphics and computer simulation APIs or SDKs, such as OpenGL, NVIDIA Omniverse, and NVIDIA Isaac.

It should be appreciated that it is important that the synthetic image be photorealistic to address the “sim-to-real gap.” Particularly, any systematic difference between simulated and real images would result in unpredictable output from the traversability detection model 20, and detection accuracy would be lower on real images versus synthetic images. In one embodiment, the processor 152 applies noise to the synthetic image to help minimize the “sim-to-real gap” and to produce more diverse training data. Another challenge is capturing the diversity of everyday life in simulation. It should be appreciated that the use of a large dataset, such as Zillow Indoor Dataset and ShapeNet, in generating the virtual environments helps to ensure diverse synthetic images are provided in the training dataset 62.

Returning to FIG. 3, the method 200 continues with determining a label mask for the synthetic image based on a simulation of a virtual robot in the virtual environment (block 230). Particularly, the processor 152 determines a label mask for the synthetic image based on a simulation of the virtual robot in the virtual environment. The label mask indicates and/or quantifies a traversability of respective regions of the virtual environment captured in respective portions of the synthetic image. In at least some embodiments, the label mask takes the form of a two-dimensional array of traversability label values having the same dimensions as the synthetic image to which it corresponds. In this way, each pixel in the synthetic images can be associated with a respective traversability label indicating and/or quantifying whether a corresponding respective location within the virtual environment can be traversed by the virtual robot. For simplicity of exposition, it can be assumed that, for example, a traversability label value at row i column j of the label mask corresponds to the pixel at row i column j in the original synthetic image.

Accordingly, in some embodiments, to determine the label mask, the processor 152 determines, for each respective pixel in the synthetic image, a respective traversability label indicating whether a corresponding respective location within the virtual environment can be traversed by the virtual robot. Finally, the processor 152 forms the label mask from the respective traversability label for each respective pixel in the synthetic image. Additionally, in some embodiments, the processor 152 determines the label mask more efficiently by checking traversability for sets of pixels rather than every pixel. For example, a 2×2 block of pixels, or, a set of pixels belonging to an object, according to an object segmentation of the image, might be checked jointly as a set of pixels. The centroid of the set could be used for ray tracing.

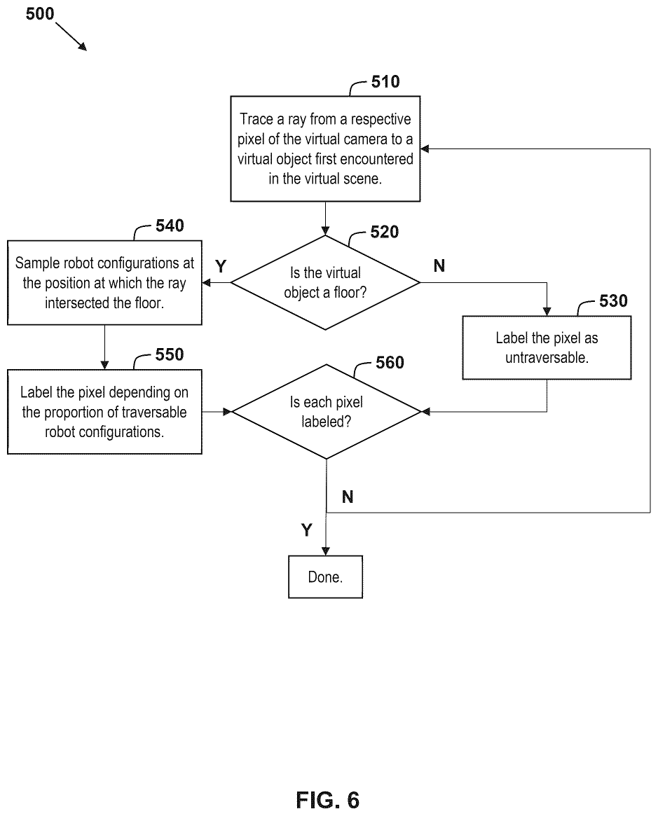

FIG. 6 shows a flow diagram for a method 500 for determining a traversability label for a particular pixel in a synthetic image. The method 500 begins with tracing a ray from a respective pixel of the virtual camera to a virtual object first encountered in the virtual scene (block 510). Particularly, for each pixel of the synthetic image and/or for each pixel of the label mask, the processor 152 traces a respective ray to a location in the scene. More particularly, the processor 152 identifies a respective location within the virtual environment corresponding to the respective pixel in the synthetic image by tracing a respective ray from the virtual camera that was used to generate the synthetic image. The respective location is a location that coincides with the respective ray.

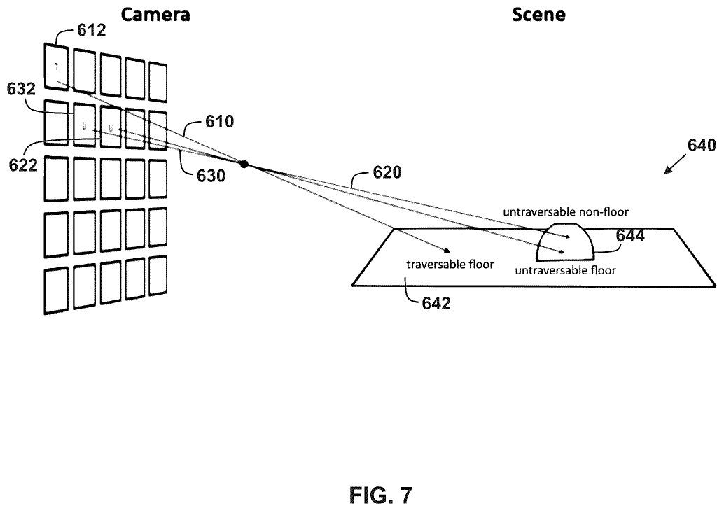

FIG. 7 summarizes the ray tracing process using a pinhole camera model. In the illustration, a first ray 610 is traced from a first pixel 612 of a virtual camera until it encounters a virtual floor 642 of a virtual environment 640. In contrast, a second ray 620 and a third ray 630 are traced from a second pixel 622 and a third pixel 632, respectively, of the virtual camera until they encounter an obstacle 644. In the illustrated example, the processor 152 traces the ray using a pinhole camera model. It should be appreciated, however, that a camera model other than a pinhole camera model can be adopted. Particularly, in some embodiments, the processor 152 traces the ray using a camera model that incorporates a lens arranged between the camera sensor and the environment that is being captured, and the ray passing through the lens is simulated

In at least some embodiments, the processor 152 determines the respective location corresponding to a respective pixel in the synthetic image as the location at which the respective ray first intersects with a virtual object. In the examples of FIG. 7, the respective location corresponding to the pixel 612 is the point at which the ray 610 intersects with the virtual floor 642. Similarly, the respective location corresponding to the pixel 622 is the point at which the ray 620 intersects with the virtual obstacle 644. Likewise, the respective location corresponding to the pixel 632 is the point at which the ray 630 intersects with the virtual obstacle 644. For embodiments in which the traversability detection model 20 will be applied to a ground-based mobile robot 120 (e.g., a robot vacuum cleaner), this location corresponding to the first encountered virtual object is generally most relevant.

However, in some embodiments, the processor 152 determines the respective location only within a predetermined maximum distance from the virtual camera. Particularly, if the respective ray does not intersect with any virtual object in the virtual environment within the predetermined maximum distance, then the processor 152 determines the respective location as the location at the predetermined maximum distance along the respective ray. Conversely, if the respective ray does intersect with a virtual object in the virtual environment within the predetermined maximum distance, the processor 152 determines the respective location as the location at which the respective ray first intersects with the virtual object. This approach may be applicable to embodiments in which the traversability detection model 20 is to be applied to a mobile robot 120 that is airborne (e.g., a UAV).

Additionally, in some embodiments, the processor 152 determines whether or not the ray casts indefinitely into space without collision. In one embodiment, the processor 152 checks for intersections at a maximum distance, which is larger than the size of the virtual environment. In another embodiment, the processor 152 checks for intersections with every polygon in the virtual environment for ray intersection. In such cases that the ray does not collide with any geometry of the virtual environment at all, the processor 152 can immediately determine the traversability. Particularly, in the case that the traversability detection model 20 is to be applied to a mobile robot 120 that is airborne (e.g., a UAV), then the processor 152 determines to pixel to be traversable. Conversely, in the case that the traversability detection model 20 is to be applied to a mobile robot 120 that is ground-based (e.g., a robot vacuum), then the processor 152 determines to pixel to be untraversable.

The method 500 continues with checking whether the first encountered virtual object is a floor (block 520). If the first encountered virtual object is not a floor, then the method 500 continues with labeling the pixel as untraversable (block 530). Particularly, the processor 152 determines the respective traversability label for the respective pixel to be ‘untraversable’ in response to the respective ray intersecting with a virtual object in the virtual environment other than a virtual floor of the environment. In other words, locations in the virtual environment corresponding to non-floor virtual objects are labeled as ‘untraversable.’ Such a labeling process is appropriate, for example, for embodiments in which the traversability detection model 20 will be applied to a ground-based mobile robot 120 (e.g., a robot vacuum cleaner).

However, in some embodiments, such as those in which the traversability detection model 20 is to be applied to a mobile robot that is airborne (e.g., a UAV), the distinction between floor and non-floor may be modified or removed. Particularly, in some embodiments, the processor 152 determines the respective traversability label for the respective pixel to be ‘untraversable’ in response to the respective ray intersecting with any portion of the virtual environment within the predetermined maximum distance from the virtual camera. In other words, for an airborne mobile robot 120, locations that intersect with any portion of the virtual environment are labeled as ‘untraversable.’

Conversely, if the first encountered virtual object is a floor, then the method 500 continues with sampling robot configurations at the position at which the ray intersected the floor (block 540). Particularly, in response to the respective ray intersecting with a virtual floor of the virtual environment, the processor 152 determines a plurality of sample configurations of the virtual robot at the corresponding respective location. As discussed above, a “configuration” of a real-world robot or of a virtual robot refers to a specification of the location of every part of the robot or every point on the robot in physical or virtual 3D space. Accordingly, using a rigid-body virtual robot as an example, the plurality of sample configurations may be characterized simply by a plurality of different orientations of the virtual robot at the respective location within the virtual environment. Referring back to the illustration of FIG. 5, the two overlapping virtual robot configurations 420 are representative of two sample configurations of the virtual robot 400 at a particular location. Similarly, using a non-rigid virtual robot as an example, the plurality of sample configurations may be further characterized by a plurality of different angles, positions, or orientations of different portions of the virtual robot at the respective location within the virtual environment.

In some embodiments, prior to the labeling process, the processor 152 determines possible configurations of the virtual robot across the entirety of the configuration space. In other words, the processor 152 determines configurations of the virtual robot for all possible locations in the virtual environment, and a subset of these configurations at a given location are used as sample configurations during the labeling of a particular pixel of the label mask and/or the synthetic image.

The processor 152 samples the configuration space of the virtual robot in the virtual environment either randomly or uniformly according to some procedure. In one embodiment, the processor 152 determines the sample configurations uniformly at random in a bounded configuration space. In another embodiment, the processor 152 determines the sample configurations randomly but with preference to regions where the current set of samples is sparse, e.g., like Rapidly Exploring Random Trees (RRT). In another embodiment, the processor 152 determines the sample configurations procedurally on a d-dimensional grid, where d is the dimension of the configuration space, and grid spacing is given ahead of time.

The method 500 continues with labeling the pixel depending on the proportion of traversable robot configurations (block 550). Particularly, for each respective sample configuration of the plurality of sample configurations, the processor 152 determines whether the virtual robot can traverse the corresponding respective location with the respective sample configuration. The traversability of each respective sample configuration is determined in a similar manner as was discussed above with respect to placing the virtual robot in the virtual scene for capturing the synthetic image.

To check whether a sample configuration of the virtual robot is in collision with an obstacle, the processor 152 determines whether the virtual robot with the sample configuration intersects with an obstacle of the virtual environment. In at least one embodiment, the processor 152 uses a 3D mesh-based collision checker, such as Open Dynamics Engine or NVIDIA Omniverse, to check if the robot is in collision with obstacles. An obstacle may include any virtual object of the virtual environment. It should be appreciated that “virtual object” as used herein may refer to any portion of the virtual environment, including virtual ground/terrain, virtual walls, virtual floors, and virtual ceilings, as well as virtual objects placed into the virtual environment that represent furniture, trees, toys, etc. In response to the virtual robot being in collision with (i.e., intersecting) an obstacle, the processor 152 determines that the sample configuration is not traversable.

To check whether a sample configuration of the virtual robot is in contact with a hazard, the processor 152 first determines whether the virtual robot with the sample configuration intersects with a virtual hazard (i.e., a virtual object labeled as a hazard) of the virtual environment, as similarly discussed above. In at least one embodiment, the processor 152 uses a 3D mesh-based collision checker, such as Open Dynamics Engine or NVIDIA Omniverse, to check if the robot is in contact with a hazardous substance. However, some hazards may be represented in the virtual environment as a flat, two-dimensional element. For example, a puddle of water may be represented by a region of a virtual surface that is labeled as a puddle of water or represented by a two-dimensional virtual object on the virtual surface. In such cases, the processor 152 also determines whether the virtual robot with the sample configuration is above a two-dimensional element corresponding to a virtual hazard (i.e., a virtual object labeled as a hazard). For example, in one embodiment, the processor 152 projects the model of the virtual robot onto the virtual floor or virtual terrain and determines whether the two-dimensional element corresponding to a hazard intersects with the projection of the virtual robot. In response to the virtual robot being in collision with (i.e., intersecting) a hazard or otherwise being in contact with a hazard (e.g., being directly above) the processor 152 determines that the sample configuration is not traversable.

Finally, to check whether a sample configuration of the virtual robot is stable, the processor 152 determines whether a center of mass of the virtual robot with the sample configuration is located over a virtual floor or is located over open space. In some embodiments, in response to the center of mass being located over open space, the processor 152 determines that the sample configuration is not traversable. In some embodiments, the processor 152 similarly checks whether multiple relevant portions of the robot (e.g., locations corresponding to wheels of the virtual robot) are located over a virtual floor or are located over open space. Additionally, or alternatively, to check whether a sample configuration of the virtual robot is stable, the processor 152 simulates motion of the virtual robot through the virtual environment in the presence of gravity a predetermined number of time steps forward. If based on the simulation, the virtual robot falls or tilts beyond a predetermined limit during this simulation, the processor 152 determines that the sample configuration is not traversable.

In some embodiments, the processor 152 additionally determines sample velocities and/or accelerations of the virtual robot, in a similar manner as generating the sample configurations. It should be appreciated that the velocity and/or acceleration of the virtual robot are derivatives of the configuration of the virtual robot. In some embodiments, the processor 152 determines whether the virtual robot will become stuck in a small gap in a virtual floor based on the sample velocities and/or accelerations.

Once the traversability of each sample configuration is determined at a respective location, the processor 152 determines a traversability label for the corresponding pixel of the label mask and/or the synthetic image based on the traversability of each sample configuration.

In some embodiments, the processor 152 determines the respective traversability label as a ratio of (i) sample configurations with which the robot can traverse the corresponding respective location and (ii) sample configurations which the robot cannot traverse the corresponding respective location. In other words, the traversability label for each pixel of the label mask and/or the synthetic image is determined according to the proportion of configurations that are traversable, in collision with obstacles, in contact with hazards (e.g., a puddle of water or pet waste), and unstable (e.g., falling). The processor 152 divides the number of traversable configurations by the total number of sample configurations. The processor 152 records this ratio in the corresponding pixel of the label mask and/or the synthetic image from which the ray originated.

Alternatively, in some embodiments, the processor 152 determines the respective traversability label as being traversable in response to determining that the corresponding respective location within the virtual environment can be traversed by the virtual robot using at least one sample configuration. In other words, the processor 152 determines the label mask as a binary mask, where a ‘1’ or ‘true’ value indicates that a traversable configuration was found at the corresponding respective location and a ‘0’ or ‘false’ value indicates that no traversable configuration was found at the corresponding respective location.

Finally, the method 500 continues with checking whether each pixel is labeled (block 560). If there are still pixels of the label mask and/or the synthetic image that have not yet been labeled, then the method 500 returns to block 510 and the process is repeated for the next pixel. Otherwise, if all pixels of the label mask and/or the synthetic image have been labeled, the method 500 concludes.

With returning reference to FIG. 3, in some embodiments, the processor 152 generates multiple label masks corresponding to different limitations on traversability or types of untraversability (e.g., obstacles, hazards, instability, or non-floors). In one embodiment, the processor 152 determines a first label mask for the synthetic image that indicates whether corresponding locations within the virtual environment are untraversable due to a first limitation on traversability (e.g., obstacles). In one embodiment, the processor 152 determines a second label mask for the synthetic image indicating whether corresponding locations within the virtual environment are untraversable due to a second limitation on traversability (e.g., hazards). In one embodiment, the processor 152 determines a third label mask for the synthetic image indicating whether corresponding locations within the virtual environment are untraversable due to a third limitation on traversability (e.g., instability). In one embodiment, the processor 152 determines a fourth label mask for the synthetic image indicating whether corresponding locations within the virtual environment are untraversable due to a fourth limitation on traversability (e.g., non-floor). Each different label mask would be determined in the same process discussed above, but the labels values in each label mask would quantify only the traversability type corresponding to the mask type.

Once the one or more label masks are determined, the processor 152 stores the label mask(s) in association with the corresponding synthetic image on the storage devices 162, i.e., as the training data 62. The method 200 continues with checking whether there is sufficient training data (block 240). To this end, in one embodiment, the processor 152 determines whether there is a threshold number of training samples, or otherwise evaluates the training dataset against some metric. If there is not yet sufficient training data, the method 200 returns to block 220 to generate a new synthetic image. Alternatively, once a threshold number of synthetic images have been generated using a particular virtual scene, the method 200 instead returns to block 210 to generate a new virtual scene within which new synthetic images will be generated.

Once there is sufficient training data, the method 200 continues with training the machine learning model based on the synthetic image and the label mask (block 250). Particularly, the processor 152 trains the traversability detection model 20 based on the synthetic images and the corresponding label masks in the collected training data 62. Particularly, once a sufficient corpus of training data 62 is generated (i.e., synthetic images with associated ground truth traversability label masks), the processor 152 executes the optimizer 64 of the trainer 60 to train the traversability detection model 20 to predict traversable and untraversable regions of an environment based on images of the environment. To this end, the processor 152 may utilize any algorithm in the art of machine learning for fitting a model to data, including gradient descent, stochastic gradient descent, Newton's method, etc. In one embodiment, the processor 152 trains the traversability detection model 20 using reinforcement learning.

In some embodiments, the synthetic training data 62 may be augmented with real training data including real images that have been manually labeled or labeled using further sensing systems, such as LIDAR or bumper sensors. Real training data can be generated by multiple human labelers and/or remote robots and pooled together over a network connection. The robot(s) used for labeling real images need not be of the same type as those used for traversability detection, e.g., they could have additional, more expensive sensors for detecting traversability, and they could have stronger, more expensive shells to avoid damage from hazards.

As discussed above, in some embodiments, multiple label masks are generated corresponding to different limitations on traversability or types of untraversability (e.g., obstacles, hazards, instability, or non-floors). Likewise, in some embodiments, the processor 152 trains multiple traversability detection models 20 corresponding to different limitations on traversability or types of untraversability. In one embodiment, the processor 152 trains a first traversability detection model 20 to predict traversable and untraversable regions of an environment due to a first limitation on traversability (e.g., obstacles) based on images of the environment. In one embodiment, the processor 152 trains a second traversability detection model 20 to predict traversable and untraversable regions of an environment due to a second limitation on traversability (e.g., hazards) based on images of the environment. In one embodiment, the processor 152 trains a third traversability detection model 20 to predict traversable and untraversable regions of an environment due to a third limitation on traversability (e.g., instability) based on images of the environment. In one embodiment, the processor 152 trains a fourth traversability detection model 20 to predict traversable and untraversable regions of an environment due to a fourth limitation on traversability (e.g., non-floor) based on images of the environment.

Once the traversability detection model 20 is trained, it can be deployed to the mobile robot. The controller 122 operates a camera and/or other sensors of the sensors 122 to capture real images of the real-world environment. Next, the controller 122 executes the traversability detection model 20 to predict traversable and untraversable regions of the real-world environment based on the captured real images, i.e., to generate a predicted label mask. Based on the predicted traversable and untraversable regions, the controller 122 executes the operating procedures 132 to generate operating commands for operating the actuators 128 to navigate the environment in a manner that avoids the untraversable regions. Alternatively, in some embodiments, the traversability detection model 20 is deployed and executed on behalf of the mobile robot 120 on a remote cloud server.

In some embodiments, in addition to training the traversability detection model 20, the processor 152 trains a further machine learning model of the operating procedures 132 to generate the commands for operating the actuators 128 to navigate the environment in a manner that avoids the untraversable regions. Particularly, the further machine learning model is configured to generate operating commands based on an image captured of the real-world environment and an associated label mask generated by the traversability detection model 20.

In one embodiment, the processor 152 trains a further machine learning model of the operating procedures 132 using the simulator 40 and reinforcement learning algorithms. To this end, the processor 152 provides as input to the further machine learning model a synthetic image of a virtual environment with an associated traversability label mask. The processor 152 executes the further machine learning model to generate operating commands as output. The processor 152 simulates operation of the virtual robot using the generated operating commands. A reward function is given which defines how the machine learning model of the operating procedures 132 should behave. In one example, a reward of 1 is received when the robot moves forward 1 meter and a reward of −10 is received when the robot hits an obstacle. Initially, the machine learning model of the operating procedures 132 causes the virtual robot to move randomly in simulation. However, over time, the machine learning model of the operating procedures 132 learns to maximize the expected future reward, as is done in the art of reinforcement learning.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for training a machine learning model configured to determine a traversability of a real-world environment by a mobile robot based on an image of the real-world environment, the method comprising:
generating a virtual environment using a plurality of three-dimensional models;
generating a synthetic image of the virtual environment;
determining a label mask for the synthetic image based on a simulation of a virtual robot in the virtual environment, the label mask indicating a traversability of respective regions of the virtual environment captured in the synthetic image; and
training the machine learning model based on the synthetic image and the label mask.

2. The method according to claim 1, the generating the virtual environment further comprising:
determining a room layout for the virtual environment, the room layout defining virtual walls and virtual floors of the virtual environment; and
determining positions of a plurality of virtual objects located within the virtual environment.

3. The method according to claim 1, the generating the synthetic image further comprising:
defining a configuration of a virtual robot within the virtual environment; and
generating the synthetic image of the virtual environment from a perspective of a virtual camera of the virtual robot with the configuration.

4. The method according to claim 3, the defining the configuration of the virtual robot further comprising:
randomly selecting a candidate configuration of the virtual robot within the virtual environment;
checking whether the candidate configuration of the virtual robot is traversable within the virtual environment; and
defining the configuration as the candidate configuration in response the candidate configuration being traversable.

5. The method according to claim 4, the checking whether the candidate configuration of the virtual robot is traversable further comprising:
determining whether the virtual robot with the candidate configuration is in collision with a virtual obstacle in the virtual environment.

6. The method according to claim 4, the checking whether the candidate configuration of the virtual robot is traversable further comprising:
determining whether the virtual robot with the candidate configuration is one of (i) in collision with and (ii) directly above a virtual hazard in the virtual environment.

7. The method according to claim 4, the checking whether the candidate configuration of the virtual robot is traversable further comprising:
determining whether the virtual robot with the candidate configuration is stably supported by a virtual floor of the virtual environment.

8. The method according to claim 1, the determining the label mask further comprising:
determining, for each respective pixel in the synthetic image, a respective traversability label indicating whether a corresponding respective location within the virtual environment can be traversed by the virtual robot; and
forming the label mask from the respective traversability label for each respective pixel in the synthetic image.

9. The method according to claim 8, the determining the respective traversability label for each respective pixel in the synthetic image further comprising:
identifying the corresponding respective location within the virtual environment by tracing a respective ray from a virtual camera used to generate the synthetic image, the corresponding respective location within the virtual environment being a location coinciding with the respective ray.

10. The method according to claim 9, wherein the corresponding respective location within the virtual environment is one of (i) a location along the respective ray at a predetermined maximum distance from the virtual camera and (ii) a location at which the respective ray first intersects with the virtual environment that is less than the predetermined maximum distance from the virtual camera.

11. The method according to claim 9, wherein the corresponding respective location within the virtual environment is a location at which the respective ray first intersects with the virtual environment.

12. The method according to claim 9, the determining the respective traversability label for each respective pixel in the synthetic image further comprising:
determining the respective traversability label as being untraversable in response to the respective ray intersecting with a virtual object in the virtual environment other than a virtual floor of the virtual environment at the corresponding respective location.

13. The method according to claim 9, the determining the respective traversability label for each respective pixel in the synthetic image further comprising, in response to the respective ray intersecting with a virtual floor of the virtual environment at the corresponding respective location:
determining a plurality of sample configurations of the virtual robot at the corresponding respective location within the virtual environment; and
determining, for each respective sample configuration of the plurality of sample configurations, whether the virtual robot can traverse the corresponding respective location with the respective sample configuration.

14. The method according to claim 13, the determining the respective traversability label for each respective pixel in the synthetic image further comprising:
determining the respective traversability label as a ratio of (i) sample configurations from the plurality of sample configurations with which the robot can traverse the corresponding respective location and (ii) sample configurations from the plurality of sample configurations with which the robot cannot traverse the corresponding respective location.

15. The method according to claim 13, the determining the respective traversability label for each respective pixel in the synthetic image further comprising:
determining the respective traversability label as being traversable in response to determining that the corresponding respective location within the virtual environment can be traversed by the virtual robot using at least one sample configuration from the plurality of sample configurations.

16. The method according to claim 13, the determining whether the virtual robot can traverse the corresponding respective location with the respective sample configuration further comprising:
determining whether the virtual robot with the sample configuration is in collision with a virtual obstacle in the virtual environment.

17. The method according to claim 13, the determining whether the virtual robot can traverse the corresponding respective location with the respective sample configuration further comprising:
determining whether the virtual robot with the sample configuration is one of (i) in collision with and (ii) directly above a virtual hazard in the virtual environment.

18. The method according to claim 13, the determining whether the virtual robot can traverse the corresponding respective location with the respective sample configuration further comprising:
determining whether the virtual robot with the respective sample configuration is stably supported by a virtual floor of the virtual environment.

19. The method according to claim 1, the determining the label mask further comprising:
determining a first label mask for the synthetic image, the first label mask indicating whether corresponding locations within the virtual environment are untraversable due to a first limitation on traversability; and
determining a second label mask for the synthetic image, the second label mask indicating whether corresponding locations within the virtual environment are untraversable due to a second limitation on traversability.

20. The method according to claim 1 further comprising:
training a second machine learning model using the trained first machine learning model, the second machine learning model being configured to generate operating commands for the mobile robot based on an image captured of the real-world environment and a label mask generated by the first machine learning model based on the image.
